(19) United States
(12) Patent Application Publication
(10) Pub. No.: US 2010/0310880 A1
(43) Pub. Date: Dec. 9, 2010

(54) HIGH-GLOSS, POLYVINYLIDENE FLUORIDE-BASED COATING SYSTEMS AND METHODS

(75) Inventors: Jay Register, Garland, TX (US); Ted Best, Bowling Green, KY (US)

Correspondence Address: KAGAN BINDER, PLLC, SUITE 200, MAPLE ISLAND BUILDING, 221 MAIN STREET NORTH, STILLWATER, MN, 55082, US

(73) Assignee: VALSPAR SOURCING,INC, Minneapolis, MN (US)

(21) Appl. No.: 12/599,073

(22) PCT Filed: May 2, 2008
(86) PCT No.: PCT/US2008/005629

§ 371 Date: Aug. 18, 2010

Related U.S. Application Data
(60) Provisional application No. 60/928,208, filed on May 8, 2007.

(51) Int. Cl. B32B 27/08; C08K 5/34; C08K 5/3415

(52) U.S. Cl. 428/421; 524/86; 524/104

(57) ABSTRACT

Solutions of polyvinylidene resins with very high vinylidene difluoride content in lactam solvent systems and their uses to form high gloss coatings, especially high gloss clear coatings. The present invention also provides coated articles incorporating these coatings. Advantageously, polyvinylidene fluoride (PVDF) resins with sufficiently high vinylidene difluoride content, as well as a wide variety of thermoplastic and thermosetting resins useful in the practice of the present invention, can be easily dissolved in and then stay dissolved in lactam solvents. Conveniently, these solutions may be prepared at room temperature. The ability to coat such PVDF resins from solution, rather than from dispersions, is a key factor leading to the high gloss characteristics provided by many embodiments of the present invention.

### PRIORITY CLAIM

The present patent application claims priority under 35 USC §119(e) from U.S. Provisional Patent Application Ser. No. 60/928,208, filed on May 8, 2007, by Register et al., and titled HIGH-GLOSS, POLYVINYLIDENE FLUORIDE-BASED COATING SYSTEMS AND METHODS, wherein the entirety of said patent application is incorporated herein by reference.

### FIELD OF THE INVENTION

The present invention relates to coating compositions incorporating polyvinylidene fluoride-based polymers and their uses to form high-gloss coatings on a wide variety of substrates.

### BACKGROUND OF THE INVENTION

Coating compositions incorporating polyvinylidene fluoride resins are known. Polyvinylidene fluoride (PVDF) resins are polymers that incorporate vinylidene fluoride repeating units. Vinylidene difluoride repeating units have the formula —[CH₂CF₂]—. Homopolymers of polyvinylidene fluoride generally incorporate only repeating units of vinylidene difluoride except at the terminal ends, whereas other forms of polyvinylidene fluoride are made by copolymerizing vinylidene difluoride repeating units with one or more other co-polymerizable repeating units. The properties of the resultant polymer product can vary considerably depending upon the nature and relative amount of other constituents incorporated into the polymer in addition to the polyvinylidene difluoride.

Polyvinylidene fluoride resins have many valuable properties that make it desirable to use these materials in a wide range of coatings. First, PVDF resins are stable towards a wide range of chemicals such as inorganic acids, lyes, sulphur dioxide, and the like. Second, coatings incorporating PVDF resins tend to be dirt-repellant, scratch-resistant, and weather-resistant. Third, PVDF resins can resist being broken down by ultraviolet radiation. Fourth, as compared to other fluoropolymers, PVDF resins are relatively economical. Under current market conditions, for instance, homopolymers of PVDF may cost less than half as much as fluoroethylene vinylether (FEVE) polymers. As a consequence of these valuable properties, PVDF coatings are used in a wide range of demanding commercial coating applications, including as constituents of colored coatings on architectural and building panels for exterior applications.

It is often desirable to apply high gloss coatings onto a wide variety of substrates. These substrates include but are not limited metals, wood, paper, ceramics and glass, polymers, leather, woven and nonwoven fabric, fibers, combinations of these (whether synthetic and/or natural), and the like. Of particular interest are substrates that include steel, aluminum, zinc, copper, as well as alloys, inter-metallic compositions, composites including one or more of these, and/or the like. Representative supplies of these substrates include, but are not limited to extrusions, coils or otherwise fabricated substrates intended to be converted into building panels, roofing panels, automotive body parts, aluminum extrusions, and the like. These substrates may be bare, primed, or color coated, and an objective would be to further apply a clear coating to these substrates to enhance their gloss and appearance.

High gloss clear coat compositions incorporating FEVE polymers have been known, but these have drawbacks. The cost-to-performance ratio of FEVE to PVDF polymers is significantly higher. Clearly, it would be very desirable to be able to fabricate and use PVDF-based high gloss clear coat compositions, but this has been technically challenging. High Gloss coatings incorporating FEVE polymers are known (U.S. Pat. No. 5,178,915). PVDF dispersions are also known, but tend to produce coatings with low to moderate gloss.

U.S. Pat. No. 3,944,689 describes preparing high gloss, air dry coatings from solutions in which the PVDF resin is a copolymer of vinylidene difluoride and polytetrafluoroethylene. However, to make the PVDF/PTFE copolymer soluble in the selected gloss enhancing solvents, the vinylidene difluoride content of workable copolymer embodiments had to be reduced to about 80 weight percent. The PVDF/PTFE copolymer also is admixed (50/50 ratio) with an acrylate polymer and must be heated to 175° F. to obtain a substantially clear solution. This complicates storage and shelf-life issues if thermosetting ingredients are to be incorporated into the formulation, inasmuch as such heating could cause premature crosslinking to occur.

The industry still needs better strategies for preparing PVDF-based, high gloss coatings and coated articles incorporating these coatings.

### SUMMARY OF THE INVENTION

The present invention provides solutions of polyvinylidene resins with very high vinylidene difluoride content in lactam solvent systems and their uses to form high gloss coatings, especially high gloss clear coatings. The present invention also provides coated articles incorporating these coatings. Advantageously, polyvinylidene fluoride (PVDF) resins with sufficiently high vinylidene difluoride content, as well as a wide variety of thermoplastic and thermosetting resins useful in the practice of the present invention, can be easily dissolved in and then stay dissolved in lactam solvents. Conveniently, these solutions may be prepared at room temperature. The ability to coat such PVDF resins from solution, rather than from dispersions, is a key factor leading to the high gloss characteristics provided by many embodiments of the present invention.

The present invention also provides one or more additional strategies that can be pursued singly or in combination with the lactam dissolution strategy in order to further enhance gloss performance. First, coating solutions can further include both thermosetting and thermoplastic ingredients to improve blushing resistance in some conditions. Second, even when both thermoplastic and thermosetting ingredients are used, embodiments of the invention limit the thermosetting content in order to limit blushing that might tend to occur in other conditions, such as upon baking that might take place to cure the coating. Limiting the thermosetting content of the coating solution can also help to reduce blushing and/or surface texturizing that might tend to occur when the coating solution is coated onto lactam sensitive substrates.

The present invention also provides additional strategies that can be pursued singly or in combination to help protect lactam sensitive substrates. As one such strategy, the coating solution itself may be formulated with at least one additional solvent in which one or more of the ingredients of the coating composition are soluble, partially soluble, insoluble, or insoluble at room temperature but soluble at an elevated temperature. If one or more of the solution ingredients are at least partially insoluble in the additional solvent, then it is desirable to limit the amount of such solvent added so that the resultant composition is still a solution. Adding such additional solvent(s) dilutes the lactam material, making it less potent with respect to the lactam sensitive substrate. Additionally, in substrates that include fluorocarbon material, thermoset material, and thermoplastic material, the amount of thermoset material can be limited in order to reduce the sensitivity of the substrate to the lactam-containing solution.

In one aspect, the present invention relates to a coating composition. The coating composition comprises a solvent component comprising at least one lactam solvent. At least one polyvinylidene fluoride resin is dissolved in the solvent component. The weight ratio of the lactam solvent to the polyvinylidene fluoride resin is at least about 2.5:1. The PVDF resin includes a sufficient amount of vinylidene difluoride repeating units of the formula —(CH₂CF₂)— and the PVDF resin has a molecular weight sufficiently low such that the PVDF resin is dissolvable and remains soluble in the solvent component at 25° C. At least one thermoplastic and/or thermosetting resin is dissolved in the solvent component, wherein the weight ratio of the at least one PVDF resin to the total weight of the thermoplastic resin if any and the thermosetting resin if any is in the range from about 0.3:1 to about 30:1.

In another aspect, the present invention relates to a coating composition comprising a solvent component comprising at least one lactam solvent. At least one polyvinylidene fluoride resin is dissolved in the solvent component. The weight ratio of the lactam solvent to the polyvinylidene fluoride resin is it least about 2.5:1. The PVDF resin has a molecular weight sufficiently low such that the PVDF resin is soluble in the solvent component at 25° C. At least one thermoplastic and at least one thermosetting resin also are dissolved in the solvent component, wherein the weight ratio of the at least one polyvinylidene fluoride resin to the total weight of the thermoplastic resin and the thermosetting resin is in the range from about 0.3:1 to about 30:1. The weight ratio of the thermoplastic resin to the thermosetting resin is greater than about 2:1.

In another aspect, the present invention relates to a coated article, comprising a clear coating derived from ingredients comprising a polyvinylidene fluoride resin having at least 90% by weight of vinylidene difluoride repeating units; and at least one of a thermoplastic resin and/or a thermosetting resin. A second coating underlies the clear coating. The second coating is derived from ingredients comprising at least one fluoropolymer, at least one thermoplastic resin, and at least one thermosetting resin, wherein the weight ratio of the at least one fluoropolymer to the total weight of the at least one thermoplastic resin and the at least one thermosetting resin is greater than about 1:1; and wherein the weight ratio of the thermoplastic resin to the thermosetting resin is greater than 1:1 with the proviso that the second coating includes less than about 20 parts by weight of the thermosetting resin per about 100 parts by weight of the total weight of the resins included in the second coating.

In another aspect, the present invention relates to a coating composition, comprising a solvent component comprising a lactam solvent and a latent solvent, wherein the solvent component includes at least about 25% by weight of the lactam solvent. A polyvinylidene fluoride resin is dissolved in the solvent component, wherein the weight ratio of the lactam solvent to the polyvinylidene fluoride resin is it least about 2.5:1. The polyvinylidene fluoride resin includes a sufficient amount of vinylidene difluoride repeating units and has a weight average molecular weight that is sufficiently low such that the polyvinylidene fluoride resin is dissolvable in and remains soluble in the lactam solvent and the solvent component at 25° C., and wherein the fluorocarbon polymer is soluble in the latent solvent, the lactam solvent, and the solvent component at a temperature greater than about 35° C. The composition also includes at least one thermoplastic vinyl resin and at least one thermosetting vinyl resin having hydroxyl functionality, wherein the weight ratio of the PVDF resin to the total weight of the thermoplastic and thermosetting resins is greater than about 0.4:1 and wherein the weight ratio of the thermoplastic resin to the thermosetting resin is greater than about 2:1. The composition also includes an aminoplast crosslinking agent present in an amount effective to crosslink at least a portion of the thermosetting resin. The composition optionally includes a blocked or unblocked catalyst that facilitates a crosslinking reaction between the thermosetting resin and the aminoplast crosslinking agent.

In another aspect, the present invention also relates to coatings prepared using any of the coating compositions described herein. In other aspects, the present invention relates to methods of using any of the coating compositions described herein to prepare coatings and coated articles.

### DETAILED DESCRIPTION OF PRESENTLY PREFERRED EMBODIMENTS

The embodiments of the present invention described below are not intended to be exhaustive or to limit the invention to the precise forms disclosed in the following detailed description. Rather the embodiments are chosen and described so that others skilled in the art may appreciate and understand the principles and practices of the present invention.

The coating compositions of the present invention generally include a solvent component, a polyvinylidene fluoride resin, a thermoplastic resin, optionally a thermosetting resin, and optionally one or more other ingredients. The solvent component generally includes at least one lactam solvent. A lactam solvent is a solvent that includes a cyclic amide moiety. Often, these cyclic moieties are four- to six-membered ring structures. Prefixes may be used to indicate the ring size. For instance, the prefixes β (beta), γ (gamma), and δ (delta) refer to 4-, 5-, and 6-membered rings, respectively. A particularly preferred dipolar, aprotic, lactam solvent useful in the practice of the present invention is the chemical compound N-methyl-2-pyrrolidone, which has the following five-membered lactam structure:

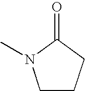

N-methyl-2-pyrrolidone is also known by other names, including NMP, 1-methyl-2-pyrrolidone, N-methyl-2-pyrrolidinone, and m-pyrrole.

Advantageously, polyvinylidene fluoride (PVDF) resins with sufficiently high vinylidene difluoride content, as well as a wide variety of thermoplastic and thermosetting resins useful in the practice of the present invention, can be easily dissolved in and then stay dissolved in lactam solvents at room temperature. The ability to coat such PVDF resins from solution, rather than from dispersions, is a key factor leading to the high gloss characteristics provided by many embodiments of the present invention.

PVDF resins with high vinylidene difluoride content can be difficult to dissolve in many reagents at room temperature, but can be readily dissolved in lactam solvents such as NMP at room temperature, particularly when the PVDF resin has an appropriate weight average molecular weight (discussed further below) and the solvent component includes a sufficient amount of the lactam solvent relative to the PVDF resin. Desirably, the solvent component includes enough of the lactam solvent such that the weight ratio of the lactam solvent to the PVDF resin is at least about 2.5:1, such as being in the range of from about 2.5:1 to about 15:1. In some embodiments, the weight ratio of the lactam solvent to the PVDF resin is at least about 5.5:1, such as being in the range of from about 5.5:1 to about 10:1.

In addition to one or more lactam solvents, the solvent component may include one or more additional solvents for a variety of purposes. For example, in addition to the dipolar, aprotic, lactam solvent, the solvent component optionally may further include one or more solvents that are latent with respect to at least the fluorocarbon resin component of the coating compositions. Because lactam solvents such as NMP are powerful solvents and can attack, degrade, or otherwise interact with some substrates, a latent solvent can be beneficially used to help protect substrates onto which the coating composition is coated. For example, NMP can sometimes interact with fluoropolymer containing surfaces such as FLUOROPON topcoats (commercially available from Valspar Corporation) upon baking in a manner that causes blushing and/or surface texturizing rather than a clear, high gloss appearance. The surface texturing undermines gloss upon unaided visual inspection and can be observed as microwrinkles under a microscope. In those embodiments where high gloss is desired, surface texturing is desirably avoided. A latent solvent can be included in a coating solvent to dilute NMP and reduce its tendency to cause such blushing and/or surface texturizing on FLUOROPON topcoats or other similar surfaces. A technical rationale explaining this effect is discussed further below.

The term “latent” with respect to such a solvent means that the PVDF resin is at least partially insoluble, and more preferably, is substantially insoluble in the solvent at room temperature; provided, however, that the PVDF resin becomes more solvated, and preferably is substantially fully soluble in the solvent when the composition is heated. Desirably, the transition from latency to solvency occurs at a temperature below a temperature at which undue thermal degradation of one or more ingredients of the coating compositions might occur.

Examples of latent solvents that would be suitable in the practice of the present invention include ketone solvents such as cyclohexanone, isophorone, dimethyl phthalate, ethylene glycol ethers, propylene glycol ethers and esters, combinations of these and the like. Cyclohexanone is presently preferred. PVDF resins suitable in the practice of the present invention, e.g., a PVDF homolpolymer having a weight average molecular weight of about 197,000 is generally insoluble in cyclohexanone at room temperature but becomes generally fully soluble in this reagent at a temperature of about 100° C.

The amount of latent solvent incorporated into the solvent component can impact the quality of the coating compositions and/or the quality of cured coatings formed from the coating compositions. For example, if too much latent solvent is used, then the solubility of the PVDF resin and potentially other resin components of the coating compositions may be reduced too much. Even if dissolution is achieved, the coating compositions might have a tendency to gel, flocculate, or suffer from other stability issues. On the other hand, if too little latent solvent is used, then the coating composition might have a tendency to interact to a greater degree than might be desired with surfaces having a sensitivity to lactam materials.

Balancing these concerns, when the coating composition is to be used over a substrate surface that might be sensitive to a lactam solvent, the solvent component includes at least one part by weight of the lactam solvent for each part by weight of latent solvent incorporated into the solvent component. One particularly preferred embodiment of a solvent component is formulated from one part by weight of NMP and one part by weight of cyclohexanone. For purposes of computing this weight ratio, any additional solvents that are present in which the PVDF resin is fully soluble at room temperature shall be deemed to be part of the lactam solvent, while any additional solvents that are present in which the PVDF resin is only at least partially insoluble at room temperature shall be deemed to be part of the latent solvent.

The total amount of the solvent component incorporated into the coating composition can vary over a wide range. As a general guideline, it is desirable that enough solvent component is present so that all the resin components of the coating composition are at least substantially fully dissolved at room temperature. It is also desirable that enough solvent component is present so that the coating composition has the appropriate rheology characteristics to correspond to the coating techniques that might be used to apply the coating compositions to substrates without having to further dilute or concentrate the coating compositions at the point of use, as a matter of convenience for the user. Balancing these concerns, and as general guidelines, it is desirable to use enough solvent component so that the coating composition includes from about 70 weight percent to about 95 weight percent, more preferably 80 weight percent to about 90 weight percent of the solvent component based upon the total weight of the coating composition.

In one particularly preferred embodiment, the coating composition includes 17.5 weight percent nonvolatile mass (+/−0.5 weight percent) and 82.5 weight percent of the solvent component (+/−0.5 weight percent). This particular embodiment has a #4 Zahn viscosity of 25 seconds at 77° F.

The PVDF resin may be any PVDF resin having a vinylidene difluoride content that is sufficiently high and a weight average molecular weight that is sufficiently low such that the PVDF resin is dissolvable in the solvent component and stays dissolved in the solvent component at 25° C. In many embodiments, the PVDF resin contains at least 90% by weight, preferably at least 95% by weight, more preferably at least 98% by weight, and most preferably is a homopolymer of repeat vinylidene difluoride units of the formula —[CH₂CF₂]—. Generally, PVDF material with greater vinylidene difluoride content is preferred. The PVDF resin may be thermoplastic or thermosetting, although thermoplastic embodiments are preferred.

PVDF resins with such high vinylidene difluoride content offer significant advantages over PVDF resins with lesser vinylidene difluoride content in that the resins with higher vinylidene difluoride content can be more readily dissolved in lactam solvents such as NMP at room temperature. In contrast, the resins with lesser vinylidene difluoride content have had to resort to other solvents and heat to achieve dissolution as is described in U.S. Pat. No. 3,944,689. Also, PVDF resins with such high vinylidene difluoride content have the potential to be more economical and more weatherable than clear coat compositions based upon fluoroethylene vinyl ether (FEVE).

Optionally, in those embodiments in which the PVDF resin is not a homopolymer of vinylidene difluoride units, the PVDF resin may include residues of one or more additional co-monomers. Monomers that may be copolymerized with vinylidene difluoride often include carbon-carbon double bonds, which may be allylic, styrenic, ethylenic, alpha-methyl styrene groups, (meth)acrylamide groups, cyanate ester groups, vinyl ether groups, (meth)acrylic moieties, or the like. Examples of such monomers include ethylene, propylene, isobutylene, styrene, vinyl chloride, vinylidene chloride, difluorochloroethylene, chlorotrifluoroethylene tetrafluoroethylene, trifluoropropylene, hexafluoropropylene, vinyl formate, vinyl acetate, vinyl propionate, vinyl butyrate, methyl (meth)acrylate, ethyl (meth)acrylate, (meth)acrylonitrile, N-butoxymethyl (meth)acrylamide, isopropenyl acetate. Others include the monomers listed below for forming vinyl resins. If thermosetting characteristics are desired, such monomers may include crosslinking functionality such as —OH, —NCO, —COOH, —NH₂, combinations of these, and the like.

The PVDF resin desirably has a molecular weight that is sufficiently low such that the PVDF resin is soluble in the solvent component at 25° C. The molecular weight of the PVDF resin desirably is in the range from about 20,000 to about 500,000, preferably from about 20,000 to 400,000, more preferably 20,000 to 300,000, and most preferably 50,000 to 200,000. As used herein, molecular weight with respect to a resin refers to the weight average molecular weight unless otherwise expressly noted.

Suitable embodiments of PVDF resins are commercially available in a variety of forms, which include pellets, fine powders, sheets, tubes bars, and the like. Fine powders are preferred as these are not only easier to dissolve in the coating compositions, but also tend to produce resultant coatings with excellent gloss characteristics. One example of a particularly preferred thermoplastic PVDF resin that is available as a fine powder and that has a weight average molecular weight of about 197,000 is commercially available under the trade designation KYNAR 711 from Arkema Inc., Philadelphia, Pa.

The coating composition of the present invention also includes at least one thermoplastic resin and/or at least one thermosetting resin, in which the vinylidene difluoride or other fluoro content of each such resin is less than about 50% by weight, preferably less than about 20% by weight, more preferably less than about 10% by weight, and even 0% by weight. The thermoplastic and/or thermosetting resins provide many benefits. First, in some embodiments, these can act like surfactants, helping to dissolve the PVDF resin in the coating composition. These also may help to improve adhesion of the resultant coating to substrates. The use of the thermoplastic and thermosetting resins also will tend to help improve the hardness and/or durability of the resultant coating. These also help to reduce costs, inasmuch as using only a fluorocarbon resin may tend to be too expensive to be cost effective. The use of these resins may also make it easier to prepare the coating compositions and/or apply the coating compositions to substrates.

Additionally, using the combination of both a thermoplastic and a thermosetting resin in addition to the fluorocarbon resin provides performance advantages, particularly in preferred embodiments in which both are present but the thermosetting content is limited. It has been found that clarity and gloss performance can suffer when only a thermoplastic or a thermosetting resin, but not both, are present when coatings are baked at relatively high temperatures and/or for relatively long periods of time. For example, blushing may occur upon boiling water tests if only a thermoplastic resin is present under such conditions, while blushing may occur upon baking if only a thermosetting resin is present. Further, blushing may still occur upon baking if too much thermosetting resin is present, even if used in combination with a thermoplastic resin. Accordingly, it is generally desirable that the weight ratio of the thermoplastic resin to the thermosetting resin is greater than about 2:1, and desirably is in a range from about 2:1 to about 50:1, preferably from about 2:1 to about 10:1. In one particularly preferred embodiment, using a weight ratio of about 4:1 was suitable. Limiting the thermosetting content in this way, and hence the corresponding thermoset content of the resultant coating, reduces and can even greatly avoid the tendency for this kind of blushing to occur.

Each of the thermoplastic and thermosetting resins may independently have a molecular weight over a wide range. As general guidelines, each independently may have a molecular weight in the range of from about 5000 to about 200,000 more preferably from about 10,000 to about 150,000. In one embodiment, a suitable thermoplastic vinyl resin obtained from methyl methacyrlate, ethyl acrylate, n-butyl methacrylate and methacrylic acid has a molecular weight of 55,000. In one embodiment, a thermosetting vinyl resin obtained from methyl methacrylate, ethyl acrylate, and 2-hydroxy acrylate has a molecular weight of 16,200. When both a thermoplastic and a thermosetting resin are used, the ratio of the molecular weight of the thermoplastic resin to the molecular weight of the thermosetting resin may vary over a wide range but generally may be in the range from about 1:4 to about 4:1, more preferably from about 1:2 to about 2:1

A wide variety of polymer materials may be used independently as the thermosetting and/or the thermoplastic resin. Examples of suitable materials include polyester, polyurethane, vinyl resins such as poly(meth)acrylic resins, polycarbonate, polyamide, polyurea, polyimide, polysulfone, polycaprolactone, polysiloxane, combinations of these, and the like. For outdoor use, where weathering resistance is desirable, polyurethanes and vinyl resins would be more suitable as these tend to be more weather resistant than some other resins. Additionally, it is desirable to limit or avoid aromatic constituents in outdoor applications, as these might have a greater tendency to yellow or degrade over time.

To provide cross-linking functionality, the thermosetting resin can be provided with one or more different kind of crosslinking functionality. Representative examples of cross-linking functionality includes OH, —NCO, —COOH, —NH₂, carbon-carbon double bonds for radiation curability, combinations of these, and the like. The cross-linking functionality may be complementary so that one kind of cross-linking functionality on the thermosetting resin material cross-links with another kind of cross-linking functionality on the thermosetting resin material with or without the assistance of a cross-linking agent and/or a cross-linking catalyst. For example, hydroxyl and isocyanate are complementary. In other embodiments, the cross-linking functionality may be the same, but the functionality is co-reactive with or without the assistance of a cross-linking agent and/or a cross-linking catalyst. For example, pendant carbon-carbon double bonds are co-reactive. As another alternative, the cross-linking functionality may only be reactive in the presence of a different functionality provided on a cross-linking agent, with or without the assistance of a catalyst. For example, hydroxy functionality by itself needs a cross-linking agent, such as an isocyanate and/or aminoplast cross-linking agent, to participate in cross-linking reactions. In the practice of the present invention, hydroxy functionality is a preferred cross-linking functionality, particularly when used in combination with aminoplast cross-linking agents.

The use of vinyl resin material for both the thermoplastic and the thermosetting resins is desirable in many applications, because the industry has wide experience and trust with the use of this class of materials in combination with PVDF resins. As used herein, the term “vinyl resin” refers to a resin obtained by the addition polymerization of one or more different kinds of monomers, oligomers, and/or polymers via carbon-carbon double bonds. Examples of carbon-carbon double bonds include allylic, styrenic, ethylenic or other olefinic, alpha-methyl styrene groups, (meth)acrylamide groups, cyanate ester groups, vinyl ether groups, (meth)acrylic moieties, and/or the like. The term “(meth)acryl”, as used herein, encompasses acryl and/or methacryl. A wide variety of one or more different monomeric, oligomeric and/or polymeric materials having one or more carbon-carbon double bonds may be used to form vinyl thermosetting or thermoplastic resins useful in the practice of the present invention. Such monomers, oligomers, and/or polymers are advantageously used to form the copolymer in that so many different types are commercially available and may be selected with a wide variety of desired characteristics that help provide one or more desired performance characteristics.

Representative examples of monofunctional, polymerizable monomers useful for forming the vinyl resins include styrene, alpha-methylstyrene, substituted styrene, vinyl esters, vinyl ethers, N-vinyl-2-pyrrolidone, (meth)acrylamide, vinyl naphthalene, alkylated vinyl naphthalenes, alkoxy vinyl naphthalenes, N-substituted (meth)acrylamide, octyl (meth)acrylate, nonylphenol ethoxylate (meth)acrylate, N-vinyl pyrrolidone, (meth)acrylonitrile, β-cyanoethyl-(meth)acrylate, 2-cyanoethoxyethyl (meth)acrylate, p-cyanostyrene, p-(cyanomethyl)styrene, isononyl (meth)acrylate, isobornyl (meth)acrylate, 2-(2-ethoxyethoxy)ethyl (meth)acrylate, 2-ethylhexyl (meth)acrylate, beta-carboxyethyl (meth)acrylate, isobutyl (meth)acrylate, cycloaliphatic epoxide, alpha-epoxide, (meth)acrylonitrile, maleic anhydride, itaconic acid, isodecyl (meth)acrylate, lauryl (dodecyl) (meth)acrylate, stearyl (octadecyl) (meth)acrylate, behenyl (meth)acrylate, n-butyl (meth)acrylate, methyl (meth)acrylate, trimethyl cyclohexyl (meth)acrylate, ethyl (meth)acrylate, hexyl (meth)acrylate, (meth)acrylic acid, N-vinylcaprolactam, stearyl (meth)acrylate, tetradecyl(meth)acrylate, pentadecyl(meth)acrylate, hexadecyl(meth)acrylate, heptadecyl(meth)acrylate, octadecyl(meth)acrylateisooctyl (meth)acrylate, tetrahydrofurfuryl (meth)acrylate, isobornyl (meth)acrylate, glycidyl (meth)acrylate vinyl acetate, combinations of these, and the like.

In order to provide a copolymer having pendant hydroxyl groups for cross-linking purposes, one or more hydroxyl functional monomers, oligomers, and/or polymers can be incorporated into the final resin. Pendant hydroxyl groups of the copolymer not only facilitate cross-linking, dispersion and interaction with the pigments in the formulation, but also promote dispersion and interaction with other ingredients in the composition. The hydroxyl groups can be primary, secondary, or tertiary, although primary and secondary hydroxyl groups are preferred. When used, hydroxy functional monomers constitute from about 0.5 to 30, more preferably 1 to about 25 weight percent of the monomers used to formulate the vinyl resin.

Representative examples of suitable hydroxyl functional monomers include a variety of esters of an α, β-unsaturated carboxylic acid with one or more diols, e.g., 2-hydroxyethyl (meth)acrylate, hydroxyisopropyl (meth)acrylate, hydroxybutyl (meth)acrylate, hydroxyisobutyl (meth)acrylate, or 2-hydroxypropyl (meth)acrylate; 1,3-dihydroxypropyl-2-(meth)acrylate; 2,3-dihydroxypropyl-1-(meth)acrylate; an adduct of an α, β-unsaturated carboxylic acid with caprolactone; an alkanol vinyl ether such as 2-hydroxyethyl vinyl ether; 4-vinylbenzyl alcohol; allyl alcohol; p-methylol styrene; or the like.

Multifunctional materials including more than one carbon-carbon double bond per molecule may also used to enhance various properties such as crosslink density, hardness, mar resistance, or the like. Examples of such higher functional, monomers include ethylene glycol di(meth)acrylate, hexanediol di(meth)acrylate, triethylene glycol di(meth)acrylate, tetraethylene glycol di(meth)acrylate, trimethylolpropane tri(meth)acrylate, ethoxylated trimethylolpropane tri(meth)acrylate, glycerol tri(meth)acrylate, pentaerythritol tri(meth)acrylate, pentaerythritol tetra(meth)acrylate, and neopentyl glycol di(meth)acrylate, divinyl benzene, combinations of these, and the like.

Suitable free radically reactive oligomer and/or polymeric materials for use in the present invention include, but are not limited to, (meth)acrylated urethanes (i.e., urethane (meth)acrylates), (meth)acrylated epoxies (i.e., epoxy (meth)acrylates), (meth)acrylated polyesters (i.e., polyester (meth)acrylates), (meth)acrylated (meth)acrylics, (meth)acrylated silicones, (meth)acrylated polyethers (i.e., polyether (meth)acrylates), vinyl (meth)acrylates, and (meth)acrylated oils.

Vinyl resins of the present invention can be prepared by a variety of additional polymerization techniques. In preferred mode of practice, vinyl resins of the present invention are prepared using free-radical polymerization methods known in the art, including but not limited to bulk, solution, and dispersion polymerization methods. The resultant vinyl resins may have a variety of structures including linear, branched, three dimensionally networked, graft-structured, combinations thereof, and the like.

The weight ratio of the PVDF resin to the total weight of the thermoplastic resin and thermosetting resin (if any) can vary over a wide range depending upon a variety of factors, including but not limited to the desired end use of the resultant coating. In representative modes of practice, the weight ratio the PVDF resin to the total weight of the thermoplastic and thermosetting resins may be in a range of from about 0.3:1 to about 30:1. In one particular spray-coating embodiment, a weight ratio of the fluoropolymer resin to total weight of the thermoplastic and thermosetting resins of 1:1 was found to be suitable where the weight ratio of the thermoplastic resin to the thermosetting resin was 4:1.

For modes of practice in which the coating composition will be applied onto substrates using techniques other than spraying, using greater amounts of the PVDF resin within such range would be more desirable. However, using too much of the PVDF resin at the higher end of such range may not be as desirable when the end use requires both durability and resilience such as might be the case when the coating of the present invention is formed on exterior architectural panels. In one particular architectural panel application, the weight ratio of the PVDF resin to the total weight of the thermoplastic and thermosetting resins is 70:25, with an additional five parts by weight of aminoplast cross-linking agent being used per 70 parts by weight of the PVDF resin.

The coating composition of the present invention optionally may include a cross-linking agent to facilitate cross-linking of the thermosetting resin when present. In preferred embodiments where the thermosetting resin includes hydroxy functionality, an aminoplast cross-linking agent is preferred. An aminoplast resin generally refers to an addition product of at least one aldehyde such as formaldehyde with at least one co-reactant containing amino- or amido-functionality. Examples of aminoplast resins include condensation products obtained from the reaction of alcohols and formaldehyde with melamine, urea, or benzoguanamine. These products can have a wide range of molecular weights. Some may be monomers, oligomers, or polymers.

Condensation products of other amines and amides can also be employed as the aminoplast cross-linking agent, for example, aldehyde condensates of triazines, diazines, triazoles, guanadines, guanamines and alkyl- and aryl-substituted melamines. Some examples of such compounds are N,N′-dimethyl urea, benzourea, dicyandimide, formaguanamine, acetoguanamine, glycoluril, ammelin 2-chloro-4,6-diamino-1,3,5-triazine, 6-methyl-2,4-diamino-1,3,5-triazine, 3,5-diaminotriazole, triaminopyrimidine, 2-mercapto-4,6-diaminopyrimidine, 3,4,6-tris(ethylamino)-1,3,5-triazine, and the like. While the aldehyde employed is most often formaldehyde, other similar condensation products can be made from other aldehydes, such as acetaldehyde, crotonaldehyde, acrolein, benzaldehyde, furfural, glyoxal and the like.

The preferred aminoplast cross-linking agent is simply a formaldehyde condensate with an amine, preferably melamine, to provide a heat-hardening methylol-functional resin. While many aminoplast resins are broadly useful, such as urea formaldehyde condensates and benzoguanamine formaldehyde condensates, it is preferred that the aminoplast resin be a polyalkoxymethyl melamine resin in which the alkoxy group contains from 1-4 carbon atoms. Appropriate melamine-formaldehyde condensates are readily available in commerce and are usually etherified with lower alcohols for use in organic solvent solution, as is well known. Examples of suitable aminoplast curing agents include an etherified melamine-formaldehyde condensate as solutions in organic solvent (e.g., a polymethoxymethyl melamine available under the trade designation CYMEL 303, available from Cytec). The aminoplast resin is typically present as from 0.1 to 10 wt. % of total resin solids, and, preferably, in an amount of from 0.2 to 3.0 wt. % of total resin solids.

While aminoplast resins are preferred for curing the hydroxy functional copolymer, it is also possible to use any curing agent reactive with hydroxy functionality, such as phenoplast resins or blocked polyisocyanates. Suitable blocked isocyanate curing agents include isophorone diisocyanate blocked with methyl ethyl ketoxime or octyl alcohol-blocked 2,4-toluene diisocyanate. The class of blocked isocyanate curing agents is well known, and these agents are well known to effect cure by forming urethane groups with the hydroxy functionality on the coating composition when baking causes the blocked isocyanate groups to dissociate and become active.

Desirably, a catalyst may be used in accordance with conventional practices to facilitate the cross-linking reaction between the hydroxy functional thermosetting resin and the aminoplast cross-linking agent. According to one representative approach, a blocked acid catalyst is used in a suitable catalytic amount. The acid is blocked with a suitable thermally labile masking group, such as an amine, so that the coating composition is substantially nonreactive at room temperature and has good storage stability. However, upon heating, the blocking amine group leaves and thereby allows the catalyst to become active and catalytically facilitate cross-linking.

The coating compositions of the present invention may also include one or more other optional ingredients. The compositions of this invention can easily be pigmented or dyed with any suitable pigments or dyes. In addition, other additives used in coating compositions optionally may be employed. These include fillers and extenders, bactericides, fungicides, flow agents, ultraviolet absorbers and stabilizers, anti-oxidants, antistatic agents, surfactants, rheology control agents, coalescing agents, and the like.

One particularly preferred embodiment of according composition generally includes from about 50 to about 75 parts by weight of the PVDF polymer containing at least about 95% by weight of —CH₂CF₂ units; from about 15 to about 30 parts by weight of resins comprising at least one thermoplastic resin and at least one optional thermosetting resin, wherein the weight ratio of the at least one thermoplastic resin to the at least one thermosetting resin (if any) is in the range from about 2:1 to about 5:1; from about two to about 10 parts by weight of an optional aminoplast cross-linking agent, which desirably is used when a hydroxy functional thermosetting resin is used; a catalytic amount of an optional catalyst to facilitate a desired catalyst reaction; and from about 150 to about 750, preferably from about 300 to about 500, parts by weight of a solvent component containing NMP and up to about 50 weight percent of cyclohexanone as a latent solvent based upon the total weight of the solvent component.

These particularly preferred coating compositions provide cured coatings, particularly cured clear coatings, having excellent gloss characteristics. For example, when applied as clear coatings at a dry film thickness of 0.4 mils (10 microns) over both high-gloss and standard FLUOROPON brand topcoats commercially available from Valspar Corp., gloss readings of 70+ at 60° were obtained over each FLUOROPON topcoat. Additionally, when applied as clear coatings at a dry film thickness of 0.2 mils (5 microns) over high-gloss and standard FLUOROPON brand topcoats commercially available from Valspar Corp., gloss readings of 70+ at 60° were obtained over the high-gloss topcoat and 60+ at 60° was obtained over the standard gloss topcoat.

The coating compositions may be prepared in a variety of ways. According to one suitable approach, the one or more fluorocarbon resins first are added with mixing to the dipolar, aprotic, lactam solvent. In representative embodiments, it is often desirable to add about one part by weight of the fluorocarbon resin(s) to from about three to about 10 parts by weight of the dipolar, aprotic, lactam solvent. This may occur with heating, but it is an advantage of the invention that this may occur at room temperature. The ingredients are mixed until all of the fluorocarbon resin is dissolved and a clear solution is obtained. A high-speed mixer, e.g., a high-speed pneumatic mixer, may be used to accomplish this. In typical mold to practice dissolution may occur over a time period ranging from about five minutes to about 60 minutes, more typically from about 10 minutes to about 25 minutes, even more typically from about 15 minutes to about 20 minutes at room temperature. If a high-speed mixing generates undue amounts of heat, the ingredients may be cooled to help dissipate as heat. Next, additional solvents to be incorporated into the solvent component may be added. For example, if a latent solvent is to be added, a latent solvent may be added at this time. If additional solvent is to be added to facilitate spray coating usage, these may be added at this time. Desirably, the additional solvents, if any, are added slowly with mixing. Together with the additional solvent material or after adding the additional solvent material, as desired, additional resin material, cross-linking agent if any, catalyst if any, and other optional ingredients may be slowly added with mixing. The resulting solution may then be mixed for an additional period of time to help ensure that all ingredients are incorporated into the solution. This additional mixing may occur at high-speed for a time period ranging from about two minutes to about four hours, more typically from about five minutes to about 30 minutes, even more typically from about 10 minutes to about 20 minutes at about room temperature.

Optionally, the coating compositions may be modified to further incorporate one or more additional solvents as additional constituents of the solvent component to dilute and lower the viscosity of the composition, making the composition more suitable for being sprayed onto substrates. If it is known ahead of time that a coating composition will be diluted in this way, it may be desirable not to include a latent solvent in the coating composition. However, there are some modes of practice in which such additional solvents may be used in a coating composition in combination with one or more latent solvents.

Examples of additional solvents that may be used to dilute coating compositions of the present invention and thereby provide embodiments suitable for use as spray formulations include methyl ethyl ketone, ethyl acetate, butyl acetate, combinations of these, and the like. Methyl ethyl ketone is an excellent diluting solvent for spray applications. However, due to the relatively polar nature of methyl ethyl ketone, relatively nonpolar solvents such as butyl acetate and/or ethyl acetate may be better solvent choices for diluting coating compositions when electrostatic spray equipment might be used. To get a good balance between a suitably fast drying rate and a reasonably wet spray application, using a combination of butyl acetate and ethyl acetate is desirable. In one particular mode of practice, a solvent mixture suitable for diluting the coating composition is prepared by mixing approximately equal parts by weight of these two solvents. A suitable spray formulation is then obtained by mixing approximately one part by weight of this additional solvent mixture with one part by weight of the pre-existing coating composition. The two components are thoroughly mixed for a suitable time period to ensure that the resultant solution is homogenous.

The coating compositions of this invention may be beneficially coated onto virtually any substrate to form coatings with very high gloss characteristics. These substrates include but are not limited to metals, wood, paper, ceramics and glass, polymers, leather, woven and nonwoven fabric, fibers, combinations of these (whether synthetic and/or natural), and the like. Particularly suitable substrates include steel, aluminum, zinc, copper, as well as alloys, inter-metallic compositions, composites including one or more of these, and/or the like. Representative supplies of the substrates include, but are not limited to extrusions, coils or otherwise fabricated substrates intended to be converted into building panels, roofing panels, automotive body parts, aluminum extrusions, and the like.

Substrate surfaces to be coated may themselves be any of a wide variety of topcoats on underlying substrates. Examples are coatings that include polyurethanes, polyesters, (meth)acrylics, fluoropolymers such as PVDF resins or fluoroethylene vinyl ether (FEVE) resins; combinations of these, or the like.

Optionally, the substrate surface may be primed prior to application of a coating composition of the present invention. Any of a variety of primers, including fluoropolymer and acrylic-based primers, known to those skilled in the art would be suitable for use in the practice of the present invention. Representative examples of primers are described in U.S. Pat. Nos. 4,684,677 and 6,017,639, each of which is incorporated herein by reference in its respective entirety for all purposes.

The coatings can be applied as one coat or can be developed in multiple passes. In any application approach, each individual layer generally is applied in a manner effective to provide dry film thicknesses in the range from about 2.5 micrometers to about 15 micrometers, preferably from about 5 micrometers to about 10 micrometers. Any coating methodology may be used, including brushing, curtain coating, coil coating, extrusion coating, roll coating, flow coating, dipping, spraying, our coating, slot coating, spin coating, or the like. The coated substrate can be air-dried but more desirably is baked under suitable conditions so that the coating composition cures to form a tough film that adheres to the substrate surface. The baking temperature is not critical, but generally is high enough to cause the coating to dry and cure (chemically, if thermosetting ingredients are present) without inducing any undue thermal degradation of the coating ingredients. If a chemical cross-linking agent is used, the temperature should be high enough for the chemical cross-linking reaction to occur at any suitable reaction rate, again without thermal degradation of the coating ingredients. By way of example, baking at a temperature in the range from about 150 degrees Celsius to about 350° C. for a time period in the range from about 10 seconds to about 30 minutes would be suitable in many instances.

Lactam solvents such as NMP are powerful solvents and can interact with some substrates in a way that undermines gloss. In other words, the promise of high-gloss offered by the coating compositions of the present invention may be undermined to some degree by the lactam sensitivity of the substrate upon which the coating composition is coated. Specifically, in some instances blushing or surface texturizing rather than a clear, high-gloss appearance may tend to develop upon baking. This has been observed to occur when a coating composition of the present invention is coated onto and cured via baking over a topcoat that includes a fluorocarbon resin, a thermoplastic acrylic resin, and a thermoset acrylic resin. The blushing and/or surface texturizing tends to become worse with increased baking temperature and/or with increased residence time at a particular baking temperature.

Analysis of the systems in which blushing and/or surface texturizing occurred showed that only those topcoats with relatively high thermoset content tended to be susceptible to the problem. Specifically, it was found that vulnerable coated systems were those in which the topcoat underlying the clearcoat included more than about 10 to about 15 parts by weight of thermoset acrylic resin per about 100 parts by weight of PVDF resin.

Without wishing to be bound by theory, it is believed that a source of the blushing and/or surface texturizing problem is due at least in part to less efficient alloying between the PVDF resin and the thermoset acrylic resin in the topcoat. A thermoset acrylic resin tends to have less efficient alloying with a PVDF resin than does a thermoplastic acrylic resin. When the topcoat includes more than about 10 to about 15 parts by weight of thermoset acrylic resin per about 100 parts by weight of fluoropolymer resin, this could mean that a portion of the fluoropolymer resin in the topcoat is non-alloyed. This non-alloyed fluoropolymer resin very likely could be more vulnerable to solvent attack by the lactam solvent when the coating composition is applied onto the topcoat, particularly at high bake temperatures. This vulnerability and associated attack is believed to be what leads to the undesired blushing and/or surface texturizing.

Also without wishing to be bound by theory, a possible alternative source of the blushing and/or surface texturizing problem may be due at least in part to a differential manner, e.g., swelling and/or contraction, by which the clearcoat material and the underlying topcoat material respond to the presence of the lactam solvent. Further, because each of a thermoplastic and a thermoset resin may tend to interact differently with a lactam solvent, the relative amount of thermoset and thermoplastic resins within each of the clearcoat and underlying topcoat materials can impact this difference between the materials to some degree. Accordingly, controlling the relative amount of thermoset and thermoplastic resin material in one or both of the clearcoat material and the underlying topcoat material may allow the two materials to swell and contract similarly in the presence of a lactam solvent.

Also without wishing to be bound by theory, it is possible that both alloying effects and differential swelling/contraction factors may be sources of the blushing and/or surface texturizing problem, at least to some degree.

Advantageously, the present invention provides multiple strategies that can be used singly or in combination to dramatically reduce blushing and/or surface texturizing and thereby allow excellent gloss to be achieved over such otherwise lactam sensitive surfaces. First, as described above, up to about 50% by weight of the solvent component of the coating composition used to form the clear coat may include a latent solvent. In practical effect, this dilutes the otherwise powerful lactam solvent in the coating composition, weakening the ability of the lactam solvent to attack the underlying topcoat. So long as the PVDF resin of the coating composition stays dissolved, this dilution advantageously occurs without unduly compromising the ability to achieve a high-gloss, cured clearcoat.

Second, the content of thermoset resin in the topcoat to be coated can be limited. Without wishing to be bound by theory, limiting the thermoset content is believed to promote the alloying efficiency between the fluoropolymer resin and the thermoplastic resin in the underlying topcoat, helping to protect the fluoropolymer resin from the lactam solvent. In representative embodiments of the invention, the topcoat onto which the coating composition is coated may be derived from ingredients that comprise from about 50 to about 100 parts by weight of a fluoropolymer resin which is preferably a PVDF resin having at least 50% by weight, more preferably at least 70% by weight, and more preferably at least 95% by weight of vinylidene difluoride units; from about 10 to about 30 parts by weight of a thermoplastic (meth)acrylic resin; and from about 0.1 up to about 15 parts by weight, preferably from about and five to about 10 parts by weight of a thermosetting (meth)acrylic resin; about 5 to about 10 parts by weight of an aminoplast cross-linking agent; and a suitable catalyst to facilitate a desired cross-linking reaction between a thermosetting resin and the cross-linking agent.

As a third strategy for reducing blushing and/or surface texturizing, the thermosetting content of the coating composition can be limited as described above, wherein the weight ratio of the thermoplastic resin to the thermosetting resin in the coating composition is at least 2:1.

The present invention will now be described with reference to the following illustrative examples.

### Example 1

### Coating Composition, Formula A

107.2 grams of Kynar 711 PVDF resin in powder form is added with mixing to 333.6 grams of NMP at room temperature. The resulting solution is mixed with a high-speed, pneumatic mixer until all the PDVF resin is dissolved and a clear solution remains. This requires approximately 15-20 minutes at room temperature. To this solution the following is added slowly with mixing: 333.6 grams of cyclohexanone, 77.0 grams of a thermoplastic acrylic resin, 14.7 grams of the thermoset acrylic, 7.0 grams of melamine (Cymel 303) and 0.3 grams of a blocked acid catalyst and 0.8 grams of a flow agent. The resulting solution is then mixed for an additional 15 minutes at high speed to incorporate all raw materials.

As used throughout these Examples, thermoplastic acrylic A refers to a thermoplastic acrylic resin incorporating 71.8 parts by weight of methyl methacrylate, 26.0 parts by weight of ethyl acrylate, 2.0 parts by weight of n-butyl methacrylate, and 0.2 parts by weight of methacrylic acid having a weight average molecular weight of 55,000. As used throughout these Examples, thermosetting acrylic B refers to a thermosetting acrylic resin incorporating 70.0 parts by weight of methyl methacrylate, 25 parts by weight of ethyl acrylate, and 5 parts by weight of 2-hydroxyethyl acrylate having weight average molecular weight of 16,200. The ingredients used in this example are summarized in the following table.

Formula A:

| | | Mass | |
|---|---|---|---|
| | | (lbs/100 | % Total |
| Component | Supplier | gallons) | Formula Wt |
| Kynar 711 | Arkema | 107.2 | 12.3 |
| N-Methyl Pyrrolidone | Ashland | 333.6 | 38.2 |
| Cyclohexanone | Ashland | 333.6 | 38.2 |
| Thermoplastic Acrylic A | N/A** | 77.0 | 8.8 |
| (40% NVM*) | | | |
| Thermosetting Acrylic B | N/A | 14.7 | 1.7 |
| (54% NVM*) | | | |
| Cymel 303 (100% NVM | Cytec | 7.0 | 0.8 |
| Melamine) | | | |
| Nacure 2500X (Blocked | King Industries | 0.3 | 0.0 |
| acid catalyst) | | | |
| Modaflow (Flow agent) | Surface Specialties Inc | 0.8 | 0.1 |
| | | 874.2 | 100.0 |

*NVM as used throughout this specification refers to the nonvolatile mass constituents of the coating composition. In these examples, the NVM constituents are all ingredients except for the solvent constituents. Also throughout these examples, thermoplastic Acrylic A is cut in PM acetate, and thermosetting Acrylic B is providing in a solvent mixture containing 3.6 parts by weight of PM acetate per 1 part by weight of xylene.
**N/A means not applicable.

### Example 2

### Coating Composition, Formula A1

The procedure of Example 1 is used to prepare a coating composition except that cyclohexanone is not used, and the solvent component includes only NMP. The ingredients and the amounts of ingredients used in this example are shown in the following table.

Formula A1:

| | | Mass | % Total |
|---|---|---|---|
| | | (lbs/100 | Formula |
| Component | Supplier | gallons) | Wt |
| Kynar 711 | Arkema | 107.2 | 12.3 |
| N-Methyl Pyrrolidone | Ashland | 667.2 | 76.3 |
| Thermoplastic Acrylic A | N/A | 77.0 | 8.8 |
| (40% NVM) | | | |
| Thermosetting Acrylic B | N/A | 14.7 | 1.7 |
| (54% NVM) | | | |
| Cymel 303 (100% NVM | Cytec | 7.0 | 0.8 |
| Melamine) | | | |
| Nacure 2500X (Blocked acid | King Industries | 0.3 | 0.0 |
| catalyst) | | | |
| Modaflow (Flow agent) | Surface Specialties Inc | 0.8 | 0.1 |
| | | 874.2 | 100.0 |

### Example 3

### Coating Composition, Formula B

The procedure of Example 1 is used to prepare a coating composition except that a thermosetting resin is not used. The ingredients and the amounts of ingredients used in this example are shown in the following table.

Formula B:

| | | Mass | % Total |
|---|---|---|---|
| | | (lbs/100 | Formula |
| Component | Supplier | gallons) | Wt |
| Kynar 711 | Arkema | 107.2 | 12.2 |
| N-Methyl Pyrrolidone | Ashland | 333.6 | 37.9 |
| Cyclohexanone | Ashland | 333.6 | 37.9 |
| Thermoplastic Acrylic A | N/A | 96.8 | 11.0 |
| (40% NVM) | | | |
| Cymel 303 (100% NVM | Cytec | 7.0 | 0.8 |
| Melamine) | | | |
| Nacure 2500X (Blocked acid | King Industries | 0.3 | 0.0 |
| catalyst) | | | |
| Modaflow (Flow agent) | Surface Specialties Inc | 0.8 | 0.1 |
| | | 879.3 | 100.0 |

### Example 4

### Coating Composition, Formula B1

The procedure of Example 1 is used to prepare a coating composition except that cyclohexanone is not used and a thermosetting resin is not used. The ingredients and the amounts of ingredients used in this example are shown in the following table.

Formula B1:

| | | Mass | % Total |
|---|---|---|---|
| | | (lbs/100 | Formula |
| Component | Supplier | gallons) | Wt |
| Kynar 711 | Arkema | 107.2 | 12.2 |
| N-Methyl Pyrrolidone | Ashland | 667.2 | 75.9 |
| Thermoplastic Acrylic A | N/A | 96.8 | 11.0 |
| (40% NVM) | | | |
| Cymel 303 (100% NVM | Cytec | 7.0 | 0.8 |
| Melamine) | | | |
| Nacure 2500X (Blocked acid | King Industries | 0.3 | 0.0 |
| catalyst) | | | |
| Modaflow (Flow agent) | Surface Specialties Inc | 0.8 | 0.1 |
| | | 879.3 | 100.0 |

### Example 5

### Coating Composition, Formula C

The procedure of Example 1 is used to prepare a coating composition except that a thermoplastic resin is not used. The ingredients and the amounts of ingredients used in this example are shown in the following table.

Formula C:

| | | Mass | % Total |
|---|---|---|---|
| | | (lbs/100 | Formula |
| Component | Supplier | gallons) | Wt |
| Kynar 711 | Arkema | 107.2 | 12.5 |
| N-Methyl Pyrrolidone | Ashland | 333.6 | 39.1 |
| Cyclohexanone | Ashland | 333.6 | 39.1 |
| Thermosetting Acrylic B | N/A | 71.7 | 8.4 |
| (54% NVM) | | | |
| Cymel 303 (100% NVM | Cytec | 7.0 | 0.8 |
| Melamine) | | | |
| Nacure 2500X (Blocked acid | King Industries | 0.3 | 0.0 |
| catalyst) | | | |
| Modaflow (Flow agent) | Surface Specialties Inc | 0.8 | 0.1 |
| | | 854.2 | 100.0 |

### Example 6

### Coating Composition, Formula C1

The procedure of Example 1 is used to prepare a coating composition except that a thermoplastic resin is not used and cyclohexanone is not used. The ingredients and the amounts of ingredients used in this example are shown in the following table.

Formula C1:

| | | Mass | % Total |
|---|---|---|---|
| | | (lbs/100 | Formula |
| Component | Supplier | gallons) | Wt |
| Kynar 711 | Arkema | 107.2 | 12.5 |
| N-Methyl Pyrrolidone | Ashland | 667.2 | 78.1 |
| Thermosetting Acrylic B | N/A | 71.7 | 8.4 |
| (54% NVM) | | | |
| Cymel 303 (100% NVM | Cytec | 7.0 | 0.8 |
| Melamine) | | | |
| Nacure 2500X (Blocked acid | King Industries | 0.3 | 0.0 |
| catalyst) | | | |
| Modaflow (Flow agent) | Surface Specialties Inc | 0.8 | 0.1 |
| | | 854.2 | 100.0 |

### Example 7

### Coating Composition, Formula D (Spray Formulation)

The procedure of Example 1 is used to prepare a coating composition except that cyclohexanone is not used, a thermosetting acrylic is not used, and a melamine (aminoplast) crosslinker and corresponding catalyst is not used. The ingredients and the amounts of ingredients used in this example are shown in the following table.

Formula D:

| | | Mass | % Total |
|---|---|---|---|
| | | (lbs/100 | Formula |
| Component | Supplier | gallons) | Wt |
| Kynar 711 | Arkema | 112.4 | 12.4 |
| N-Methyl Pyrrolidone | Ashland | 673.9 | 74.5 |
| Thermoplastic Acrylic (40% | N/A | 118.0 | 13.0 |
| NVM) | | | |
| Modaflow (Flow agent) | Surface Specialties Inc | 0.4 | 0.0 |
| | | 904.7 | 100.0 |

### Example 8

### Coating Composition, Formula E (Spray Formulation)

The procedure of Example 1 is used to prepare a coating composition except that cyclohexanone is not used, a thermosetting acrylic is not used, and a melamine (aminoplast) crosslinker and corresponding catalyst is not used. The ingredients and the amounts of ingredients used in this example are shown in the following table.

Formula E:

| | | Mass | % Total |
|---|---|---|---|
| | | (lbs/100 | Formula |
| Component | Supplier | gallons) | Wt |
| Kynar 711 | Arkema | 95.1 | 10.6 |
| N-Methyl Pyrrolidone | Ashland | 570.3 | 63.5 |
| Thermoplastic Acrylic (40% | N/A | 232.9 | 25.9 |
| NVM) | | | |
| Modaflow (Flow agent) | Surface Specialties Inc | 0.3 | 0.0 |
| | | 898.6 | 100.0 |

### Example 9

### Coating Composition, Formula F (Spray Formulation)

The procedure of Example 1 is used to prepare a coating composition except that cyclohexanone is not used, a thermoplastic acrylic is not used, and a melamine (aminoplast) crosslinker and corresponding catalyst is not used. The ingredients and the amounts of ingredients used in this example are shown in the following table.

Formula F:

| | | Mass | |
|---|---|---|---|
| | | (lbs/100 | % Total |
| Component | Supplier | gallons) | Formula Wt |
| Kynar 711 | Arkema | 116.7 | 12.9 |
| N-Methyl Pyrrolidone | Ashland | 699.4 | 77.1 |
| Thermoset Acrylic (54% | N/A | 90.7 | 10.0 |
| NVM) | | | |
| Modaflow (Flow agent) | Surface Specialties Inc | 0.4 | 0.0 |
| | | 907.2 | 100.0 |

### Example 10

### Coating Composition, Formula G (Spray Formulation)

The procedure of Example 1 is used to prepare a coating composition except that cyclohexanone is not used, a thermoplastic acrylic is not used, and a melamine (aminoplast) crosslinker and corresponding catalyst is not used. The ingredients and the amounts of ingredients used in this example are shown in the following table.

Formula G:

| | | Mass | % Total |
|---|---|---|---|
| | | (lbs/100 | Formula |
| Component | Supplier | gallons) | Wt |
| Kynar 711 | Arkema | 102.6 | 11.4 |
| N-Methyl Pyrrolidone | Ashland | 614.8 | 68.1 |
| Thermoset Acrylic (54% NVM) | N/A | 185.4 | 20.5 |
| Modaflow (Flow agent) | Surface Specialties | 0.4 | 0.0 |
| | Inc | | |
| | | 903.2 | 100.0 |

### Example 11

### Coating Composition Alternatives

The following table shows how additional coating composition alternatives can be obtained by combining relative amounts (parts by weight) of Formulae D and F on the one hand, or Formulae E and G on the other, to obtain coating compositions in which the resins solids of the resultant alternatives may include either 70% and 50% by weight PVDF resin, respectively.

| 70% PVDF Solids | 50% PVDF Solids |
|---|---|
| 80:20 D:F | 80:20 E:G |
| 70:30 D:F | 70:30 E:G |
| 60:40 D:F | 60:40 E:G |
| 50:50 D:F | 50:50 E:G |
| 40:60 D:F | 40:60 E:G |
| 30:70 D:F | 30:70 E:G |
| 20:80 D:F | 20:80 E:G |

Optionally, any formulation in any of Examples 3 through 13 can be diluted to be made more suitable for some spray mode formulations with solvents such as methyl ethyl ketone, butyl acetate, ethyl acetate, a 50:50 (by weight) mix of butyl acetate and ethyl acetate), or the like. In representative modes of practice, one part by volume of the coating composition is diluted with one part by volume of the diluting solvent.

### Example 12

A coating composition made only with N-methylpyrrolidone, such as Formula A1, is observed to have detrimental effects on a lactam sensitive surface such as a FLUROPON including greater than about 10 to about 15 parts per hundred thermoset acrylic resin content per 100 parts resin solids included in the FLUROPON formulation. A texturized appearance and/or lowering of gloss can occur when the 70% PVDF solution clearcoat of Formula A1 is applied and is baked over such a surface. Because the solvency of the N-methylpyrrolidone increases at higher temperatures, a high temperature bake (e.g., 565° F.) increases the activity of the N-methylpyrrolidone over such a surface. This detrimental effect also increases when the coated surface is baked for a longer period in an electric oven (625° F.). A possible explanation for this N-methylpyrrolidone solvent interaction with FLUROPON topcoats with the high thermoset acrylic content, could be due to the poorer alloying efficiency of thermoset acrylics with PVDF resin in the FLUROPON coating versus that of thermoplastic acrylics. This poor alloying efficiency of the thermoset acrylics could leave “non-alloyed” PVDF resin vulnerable to solvent attack by the N-methylpyrrolidone at the high bake temperatures. Indeed, by reducing the amount of thermoset content in an otherwise identical FLUROPON coating onto which the coating composition is applied and baked, the texturizing effect is significantly reduced.

### Example 13

FLUROPON (abbreviated Flpn in the following table) colorcoats (also referred to as topcoats) were applied onto hot dipped galvanized metal having a thickness of 0.017 inches that had been heated to remove moisture and primed with a polyester primer. Topcoats were applied at a dry film thickness of 0.7-0.75 mils (18-20 micrometers). Three different clearcoats were applied onto the topcoats at dry film thicknesses of 0.2 mil (5 micrometers) and 0.4 mils (10 micrometers). The VALFLON High Gloss (HG) Clearcoat referred to in this table is a state of the art, FEVE-based clearcoat commercially available from the Valspar Corporation. The FLUROPON HG Clearcoat referred to in this table is a state of the art, PVDF dispersion-based clear coat commercially available from the Valspar Corporation. For comparison, clearcoats were not used on three of the topcoats.

After applying the topcoats, or the clearcoats as the case may be, panels are respectively baked in a high velocity oven (565° F.) for 15 seconds for a 465° F. peak metal temperature (PMT) and 18 seconds for a 490° F. PMT. The coating combinations and peak metal temperatures are listed below in the following table.

| | | PMT (° F.) | | | PMT (° F.) |
|---|---|---|---|---|---|
| Colorcoat | Colorcoat | to cure | DFT | Description of | to cure |
| Nickname | Description | colorcoat | (mils) | clearcoat | clearcoat |
| Red | Flpn Red | 490 F. | | None | NA |
| Blue | Flpn Blue | 490 F. | | None | NA |
| Teal | Flpn HG Teal | 465 F. | | None | NA |
| Red | Flpn Red | 465 F. | 0.4 | Flpn HG Clearcoat | 490 F. |
| | | | | (40-50) | |
| Blue | Flpn Blue | 465 F. | 0.4 | Flpn HG Clearcoat | 490 F. |
| | | | | (40-50) | |
| Teal | Flpn HG Teal | 465 F. | 0.2 | Formula A | 490 F. |
| | (50-60) | | | | |
| Teal | Flpn HG Teal | 465 F. | 0.4 | Formula A | 490 F. |
| | (50-60) | | | | |
| Red | Flpn Red | 465 F. | 0.2 | Formula A | 490 F. |
| Red | Flpn Red | 465 F. | 0.4 | Formula A | 490 F. |
| Blue | Flpn Blue | 465 F. | 0.2 | Formula A | 490 F. |
| Blue | Flpn Blue | 465 F. | 0.4 | Formula A | 490 F. |
| Red | Flpn Red | 465 F. | 0.4 | Formula A | 490 F. |
| Blue | Flpn Blue | 465 F. | 0.4 | Valflon HG Clearcoat | 490 F. |

The following table shows how each coated article bearing Formula A performs. Note that the Fluoropon HG Clearcoat samples (based upon a PVDF dispersion) generally provide gloss readings of only about 40 to 60, while the VALFLON HG Clearcoat sample has a gloss of about 70+.

| Physicals | TEAL | RED | BLUE |
|---|---|---|---|
| Clearcoat DFT (mils) | 0.2 | 0.2 | 0.2 |
| Topcoat Gloss (@60°) | 59 | 24 | 24 |
| Gloss @ 60° | 74 | 62 | 66 |
| Pencil | HB | HB | HB |
| MEK Rubs | 100 | 90 | 75 |
| T-Bend (NFX/NTO)* | 1T/1T | 1T/1T | 1T/1T |
| X-Hatch/Rev Imp | minor FX/NTO | minor FX/NTO | minor FX/NTO |
| (45″ lbs) | | | |
| Boiling H2O | 100% | 100% | 100% |
| (1 hour)** | | | |
| Clearcoat DFT (mils) | 0.4 | 0.4 | 0.4 |
| Topcoat Gloss (@60°) | 59 | 24 | 24 |
| Gloss @ 60° | 76 | 72 | 75 |
| Pencil | HB | HB | HB |
| MEK Rubs | >150 | >150 | >150 |
| T-Bend (NFX/NTO)* | 1T/1T | 1T/1T | 1T/1T |
| X-Hatch/Rev Imp | minor FX/NTO | NFX/NTO | NFX/NTO |
| (45″ lbs) | | | |
| Boiling H2O | 100% | 100% | 100% |
| (1 hour)** | | | |

*NFX/NTO = No Fracture/No Tape Off
**Boiling water performed on cross-hatch reverse impact (45″ lbs = 3X metal thickness). Value represents percent adhesion after boiling 1 hour.

### Example 14

In this example, clear coating solutions containing PVDF resin at a content of 70% and 50% of the solids (Spray Formulae D and E, respectively) each is applied wet-on-dry over a FLUROPON colorcoat, which is a PVDF dispersion-based composition in which 70% by weight of the solids is PVDF resin. The substrate is MEK-cleaned aluminum to which a PVDF primer (733×310 from Valspar Corp.) is applied to a dry film thickness (DFT) of 0.2-0.25 mils. The primer is flashed and then the FLUROPON colorcoat is applied to a DFT of 0.8-1.0 mil. After application, the colorcoat is flashed at 170° F. for 5 minutes and then baked at 450° F. for 10 minutes. On two samples, the 50% and 70% solids clear coating solutions (0.2-0.3 mil) are applied, flashed at 170° F. for 5 minutes and baked ten minutes at 450° F. On another sample for comparison, a FLUROPON clearcoat (a PVDF dispersion) is applied after the Fluoropon colorcoat completes flashing. The Fluoropon clearcoat is then flashed 5 minutes at 170° F. and is baked 10 minutes at 450° F. For comparison, a FEVE-based clear coat (VALFLON clearcoat available from Valspar) was also applied and tested.

The following table shows data that is obtained upon testing the samples prepared in this example.

Physicals

| Clearcoat Type | Flpn clear | Valflon | 70% PVDF Soln. | 50% PVDF Soln. |
|---|---|---|---|---|
| Clearcoat DFT (mils) | 0.3-0.4 | 0.3-0.4 | 0.2-0.3 | 0.2-0.3 |
| Topcoat Gloss (@60°) | 44 | 44 | 44 | 44 |
| Gloss @ 60° | 63 | 75 | 73 | 73 |
| Pencil | F | F | F | F |
| MEK Rubs | >150 | >150 | >150 | >150 |
| Direct Impact (20″ lbs) | minor FX** | minor FX | minor FX | minor FX |
| Boiling H2O (1 hour)* | 100% | 100% | 100% | 100% |

*Percent adhesion
**FX as used herein is an abbreviation for “fracture”.

Other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by the following claims.

1. A coating composition, comprising:
(a) a solvent component comprising at least one lactam solvent;
(b) at least one polyvinylidene fluoride (PVDF) resin dissolved in the solvent component, wherein the weight ratio of the lactam solvent to the polyvinylidene fluoride resin is at least about 2.5:1; and wherein (i) the PVDF resin includes a sufficient amount of vinylidene difluoride repeating units of the formula —(CH₂CF₂)— and (ii) said PVDF resin has a molecular weight sufficiently low such that the PVDF resin is dissolvable and remains soluble in the solvent component at 25° C.; and
(c) at least one thermoplastic resin and/or at least one thermosetting resin dissolved in the solvent component, wherein the weight ratio of the at least one PVDF resin to the total weight of the thermoplastic resin if any and the thermosetting resin if any is in the range from about 0.3:1 to about 30:1.

2. (canceled)

3. (canceled)

4. The coating composition of claim 1, wherein the lactam solvent comprises N-methylpyrrolidone.

5. The coating composition of claim 1, wherein the solvent component further comprises a latent solvent.

6. (canceled)

7. (canceled)

8. (canceled)

9. The coating composition of claim 1, wherein the polyvinylidene fluoride resin comprises at least 90% by weight of the vinylidene difluoride repeating units.

10. The coating composition of claim 1, wherein the polyvinylidene fluoride resin comprises at least 98% by weight of the vinylidene difluoride repeating units.

11. The coating composition of claim 5, wherein the latent solvent comprises cyclohexanone.

12. The coating composition of claim 1, wherein the polyvinylidene fluoride resin is a homopolymer.

13. (canceled)

14. (canceled)

15. (canceled)

16. The coating composition of claim 1, comprising both at least one thermoplastic resin and at least one thermosetting resin.

17. The coating composition of claim 16, wherein each of the thermoplastic and thermosetting resins is independently a vinyl resin.

18. A coating composition, comprising:
(a) a solvent component comprising at least one lactam solvent;
(b) at least one polyvinylidene fluoride (PVDF) resin dissolved in the solvent component, wherein the weight ratio the lactam saw went to the polyvinylidene fluoride resin is it least about 2.5:1, and wherein the PVDF resin has a molecular weight sufficiently low such that the PVDF resin is soluble in the solvent component at 25° C.; and
(c) at least one thermoplastic resin dissolved in the solvent component, wherein the weight ratio of the at least one polyvinylidene fluoride resin to the thermoplastic resin is in the range from about 0.3:1 to about 30:1.
(d) at least one thermosetting resin dissolved in the solvent component, wherein the weight ratio of the thermoplastic resin to the thermosetting resin is greater than about 2:1.

19. (canceled)

20. A coated article, comprising:
(a) a clear coating derived from ingredients comprising a polyvinylidene fluoride (PVDF) resin having at least 90% by weight of vinylidene difluoride repeating units; and at least one thermoplastic resin and/or at least one thermosetting resin; and
(b) a second coating underlying the clear coating, said second coating being derived from ingredients comprising at least one fluoropolymer, at least one thermoplastic resin, and at least one thermosetting resin, wherein the weight ratio of the at least one fluoropolymer to the total weight of the at least one thermoplastic resin and the at least one thermosetting resin incorporated into the second coating is greater than about 1:1; and wherein the weight ratio of the thermoplastic resin to the thermosetting resin in the second coating is greater than 1:1 with the proviso that the second coating includes less than about 20 parts by weight of the thermosetting resin per about 100 parts by weight of the total weight of fluoropolymer included in the second coating.

21. A coating composition, comprising:
(a) a solvent component comprising a lactam solvent and a latent solvent, wherein the solvent component includes at least about 25% by weight of the lactam solvent;
(b) a polyvinylidene fluoride resin dissolved in the solvent component, wherein the weight ratio of the lactam solvent to the polyvinylidene fluoride resin is it least about 2.5:1, and wherein the polyvinylidene fluoride resin includes a sufficient amount of vinylidene difluoride repeating units and has a weight average molecular weight that is sufficiently low such that the polyvinylidene fluoride resin is dissolvable in and remains soluble in the lactam solvent and the solvent component at 25° C., and wherein the PVDF resin is soluble in the latent solvent, the lactam solvent, and the solvent component at a temperature greater than about 35° C.;
(c) at least one thermoplastic vinyl resin and at least one thermosetting vinyl resin having hydroxyl functionality, wherein the weight ratio of the PVDF resin to the total weight of the thermoplastic and thermosetting resins is greater than about 0.4:1 and wherein the weight ratio of the thermoplastic resin to the thermosetting resin is greater than about 2:1;
(d) an aminoplast crosslinking agent present in an amount effective to crosslink at least a portion of the thermosetting resin; and
(e) optionally a blocked or unblocked catalyst that facilitates a crosslinking reaction between the thermosetting resin and the aminoplast crosslinking agent.

22. A coating prepared using the coating compositions of claim 1.

23. A method of using the coating compositions of claim 1 to prepare a coated substrate.
